(19) United States
(12) Patent Application Publication
(10) Pub. No.: US 2026/0193920 A1
(43) Pub. Date: Jul. 9, 2026

(54) METHOD FOR ASSEMBLING A GUIDE SYSTEM FOR GUIDING AT LEAST ONE MOVABLY MOUNTED DOOR LEAF ALONG A FURNITURE WALL

(71) Applicant: Julius Blum GmbH, Hoechst (AT)

(72) Inventors: Lukas Kolhaupt, Lauterach (AT); André Hammerer, Alberschwende (AT); Matthias Jaeger, Dornbirn (AT); Lukas Schreiber, Feldkirch (AT)

(21) Appl. No.: 19/553,927

(22) Filed: Mar. 2, 2026

Related U.S. Application Data
(63) Continuation of application No. PCT/AT2024/060305, filed on Aug. 14, 2024.

(30) Foreign Application Priority Data
Sep. 7, 2023 (AT) A 50715/2023

(51) Int. Cl. E05D 15/58

(52) U.S. Cl. CPC E05D 15/58; E05Y 2201/654; E05Y 2201/668; E05Y 2600/56; E05Y 2900/212

(57) ABSTRACT

A method of mounting a guide system includes, preferably in the specified order, providing a furniture wall, positioning, preferably resting, an arrangement including at least two guide rails and a cable arranged therebetween on the furniture wall, fixing, preferably screwing, one of the two guide rails to the furniture wall, preferably to an end of the at least one furniture wall, moving the other of the two guide rails relative to the guide rail that is already fixed to the at least one furniture wall in a direction extending transversely to the longitudinal direction of the guide rails, thereby increasing a distance between the two guide rails, and increasing a length of a cable section of the cable arranged between the two guide rails when the distance between the two guide rails is increased.

The present application is a continuation of International Application PCT/AT2024/060305 filed on Aug. 14, 2024. Thus, all of the subject matter of International Application PCT/AT2024/060305 is incorporated herein by reference.

### BACKGROUND OF THE INVENTION

The present invention relates to a method for mounting a guide system for guiding at least one movably-supported door wing along a furniture wall, the guide system including at least two guide rails having a longitudinal direction and each having at least one guide device supported thereon for guiding a carrier to be connected to the at least one door wing. The at least two guide rails are connected to each other via at least one cable of a cable pulley device for compensating for a tilting moment of the carrier about a tilting axis by a return moment.

Further, the invention concerns a guide system for guiding at least one movably-supported door wing along a furniture wall.

Such guide systems are typically used to guide at least one door wing which is insertable in a depth direction of the item of furniture along a furniture wall into a furniture carcass, or into a receiving compartment located laterally beside the furniture carcass.

A particular challenge when guiding such a door wing is that the door wing tends to perform a tilting movement due to the weight force. This tilting of the door wing also causes an inclined position of the carrier and the two guide devices to tilt, and the guide devices can get jammed with their associated guide rails. In the event of such a jamming, a movement of the door wing is impossible or at least significantly impeded. Therefore, a primary goal is to ensure that the two guide devices are guided relative to their associated guide rails in a way that prevents them from tilting as much as possible.

Guide systems for a door wing with a cable pulley device for stabilizing a door wing are disclosed, for example, in US 2007/0159037A1 (FIG. 4), WO 2018/129568 A1 (FIG. 5a), DE 197 09 461 A1 (FIG. 5), EP 1 394 349 A1 (FIG. 1) and in EP 0 128 503 A1 (FIG. 3). However, the mounting operation is complicated and can frequently be done only by qualified personnel.

### SUMMARY OF THE INVENTION

It is an object of the present invention to propose a method and a guide system of the type mentioned in the introductory part, in which the mounting operation of the cable pulley device can be simplified.

According to the invention, the method includes the following, preferably in the specified order chronological, method steps:
providing at least one furniture wall,
positioning, preferably resting, an arrangement comprising the at least two guide rails and the at least one cable arranged therebetween on the at least one furniture wall,
fixing, preferably screwing, one of the two guide rails to the at least one furniture wall, preferably to an end of the at least one furniture wall,
moving the other of the two guide rails relative to the guide rail that is already fixed to the at least one furniture wall in a direction extending transversely to the longitudinal direction of the guide rails, thereby increasing a distance between the two guide rails, and
increasing a length of at least one cable section of the cable arranged between the two guide rails when the distance between the two guide rails is increased.

The guide system according to the invention includes an arrangement comprising the two guide rails and the at least one cable arranged therebetween. In a delivery condition of the arrangement, the two guide rails are arranged relative to each other at a first distance in a direction extending transversely to the longitudinal direction of the two guide rails. In a mounted condition on the furniture wall, the guide rails are arranged relative to each other at a second distance, the second distance being larger than the first distance. Upon a transfer of the two guide rails from the delivery condition into the mounted condition, a length of the at least one cable section of the cable arranged between the two guide rails can be increased. Preferably, in the delivery condition, an end of the at least one cable projects over a component of the arrangement, preferably over one of the guide rails, and can be shortened upon a transfer of the two guide rails from the delivery condition into the mounted condition.

In other words, at least two guide rails are provided, the at least two guide rails being connected to each other via at least one cable of the cable pulley device. In a first step, a first guide rail is fixed to a furniture wall. In a further step, the second guide rail is moved relative to the guide rail, that is pre-fixed to the furniture wall, in a direction extending transversely to the longitudinal direction of the guide rails, and a length of the cable can be increased.

In a further step, the second guide rail is fixed to the furniture wall. In a further step, the cable of the cable pulley device is tensioned relative to the guide rails that are fixed to the furniture wall.

### BRIEF DESCRIPTION OF THE DRAWINGS

Further details and advantages of the present invention will be apparent from the following description with reference to the drawings, in which:

FIGS. 1a, 1b are perspective views of an item of furniture comprising a furniture carcass and door wings movable relative thereto,

FIGS. 2a, 2b show the item of furniture according to FIGS. 1a, 1b with the door wings in further positions relative to each other,

FIG. 3 shows the guide system in a perspective view,

FIG. 4 shows the guide system in a schematic side view,

FIG. 5 shows the guide system with the cable pulley device in a schematic side view,

FIG. 6a-6c show schematically the execution of the method for mounting a guide system in temporally subsequent steps,

FIG. 7a-7c show schematically the continuation of the method according to FIGS. 6a-6c in temporally subsequent steps,

FIG. 8a-8c show schematically the continuation of the method according to FIGS. 7a-7c in temporally subsequent steps,

FIGS. 9a, 9b show schematically the continuation of the method according to FIGS. 8a-8c in temporally subsequent steps.

### DETAILED DESCRIPTION OF THE INVENTION

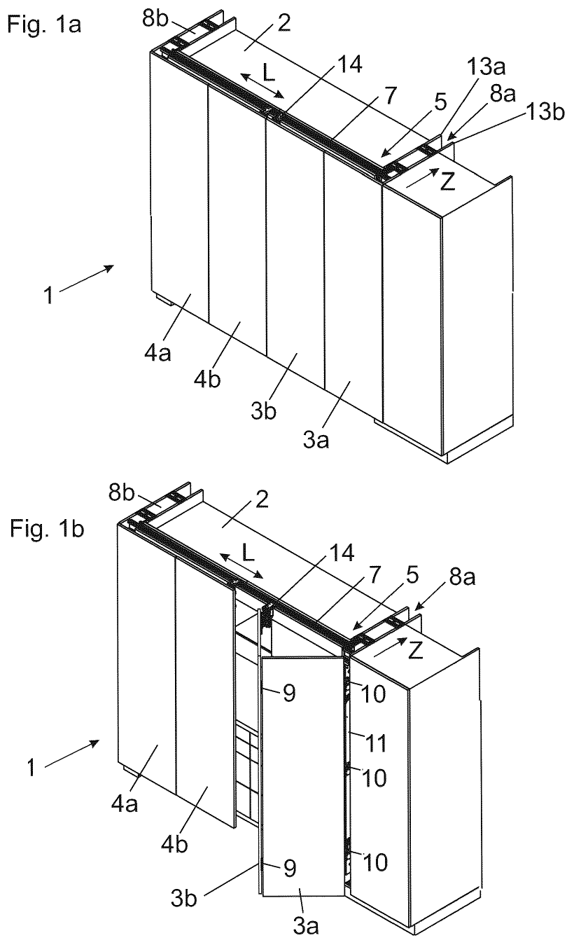

FIG. 1a shows a perspective view of an item of furniture 1 comprising a furniture carcass 2 and at least one door wing 3a, 3b; 4a, 4b movably-supported relative to the furniture carcass 2.

In the shown embodiment, a folding-sliding-door is provided, in which the door wing 3a and the door wing 3b are hingedly connected to each other via a vertically extending first pivoting axis. The two other door wings 4a, 4b are hingedly connected to each other via a vertically extending second pivoting axis.

The door wings 3a, 3b and the door wings 4a, 4b are each movable by a guide system 5 between a first position, in which the door wings 3a, 3b; 4a, 4b are aligned substantially coplanar to each other, and a second position, in which the door wings 3a, 3b; 4a, 4b are aligned substantially parallel to each other.

In the second (parallel) position, the door wings 3a, 4b can be inserted into a lateral receiving compartment 8a of the furniture carcass 2, whereas the two other door wings 4a, 4b, in a parallel position to each other, can be inserted into a further receiving compartment 8b. The functionality will be explained in the following with the aid of the door wings 3a and 3b, and the same explanations are valid for the door wings 4a, 4b.

The guide system 5 includes a guide 7 having a longitudinal direction L, and a running carriage 14 to be coupled to the second door wing 3b is displaceably supported along the guide 7. In a mounted position, the guide 7 is aligned substantially horizontally and parallel to a front edge of the furniture carcass 2. Preferably, the guide 7 is configured as a guide rail.

FIG. 1b shows the item of furniture 1, in which the door wings 3a, 3b have been moved from the coplanar position, as shown in FIG. 1a, into an angled position relative to each other. For example, the first door wing 3a can be pivotally supported on a carrier 11 via two or more furniture hinges 10, and the carrier 11 (jointly with the two door wings 3a, 3b) is insertable in the depth direction Z into a receiving compartment 8a.

The carrier 11, in the shown figure, is located in a transfer position in which the carrier 11 adjoins the guide 7 in the longitudinal direction L such that the running carriage 14 can be transferred to and from between the guide 7 and the carrier 11. In the shown transfer position, the carrier 11 is releasably locked relative to the guide 7, and the locking of the carrier 11 is releasable by an entry of the running carriage 14 in or onto the carrier 11.

The carrier 11 is in the form of a longitudinally extending column, the length of which corresponding to at least half of a height of the door wings 3a, 3b. The two door wings 3a, 3b are hingedly connected to each other via at least one hinge fitting 9 and are pivotable about a vertically extending pivoting axis in the mounted position. The second door wing 3b is displaceably guided along the guide 7 via the running carriage 14.

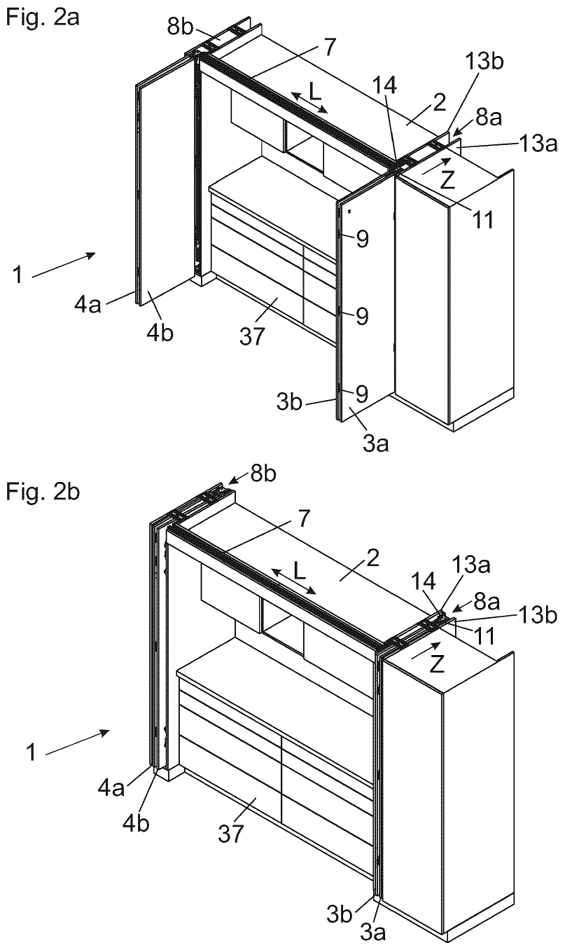

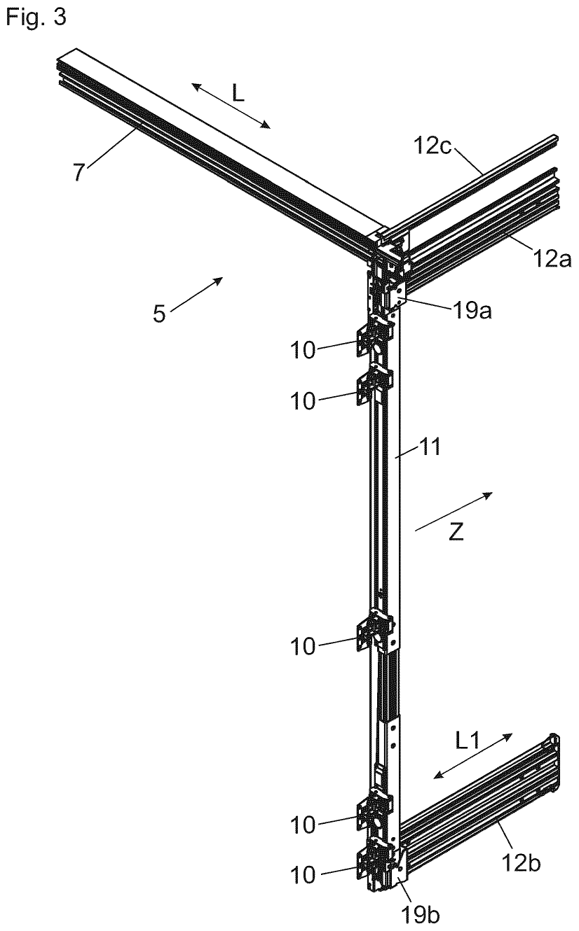

FIG. 2a shows the item of furniture 1 with the door wings 3a, 3b which are now aligned parallel to each other. The carrier 11 has been unlocked from the guide 7 by an entry of the running carriage 14, so that the carrier 11 (jointly with the running carriage 14 and the door wings 3a, 3b) is insertable in the depth direction Z along at least two guide rails 12a, 12b (FIG. 3) of the guide system 5 into the receiving compartment 8a, the at least two guide rails 12a, 12b being spaced apart from each other in the height direction.

FIG. 2b shows the item of furniture 1 with the door wings 3a, 3b which are now located in a fully inserted condition within the receiving compartment 8a. Accordingly, the door wings 3a, 3b are movably supported by the guide system 5 between a first position according to FIG. 1a, in which the door wings 3a, 3b are aligned substantially coplanar to each other, and a second position according to FIG. 2b, in which the door wings 3a, 3b are aligned substantially parallel to each other and can be received within the receiving compartment 8a. In this way, for example, a kitchen 37 as shown in FIGS. 2a, 2b can be entirely covered, so that the kitchen 37 can be visually separated from a remaining area of a living room.

The receiving compartment 8a, in the shown embodiment, is formed by a first furniture wall 13a and by a second furniture wall 13b spaced apart from the first furniture wall 13a in a substantially parallel relationship, and the door wings 3a, 3b can be received between the two furniture walls 13a, 13b when aligned parallel to each other.

FIG. 3 shows the guide system 5 in a perspective view. By the guide 7, the door wings 3a, 3b can be guided along a front side of the furniture carcass 2. The carrier 11 is configured for pivotally supporting the first door wing 3a and can include at least one furniture hinge 10 or a plurality of furniture hinges 10 spaced apart from each other along a longitudinal direction of the carrier 11. The carrier 11 is displaceably supported in the depth direction Z via a first guide device 19a along a first guide rail 12a, and via a second guide device 19b along a second guide rail 12b. The carrier 11 and/or the guide devices 19a, 19b can include at least one rolling body which is displaceably supported along a guide rail 12a, 12b.

Preferably, the carrier 11 and/or the guide devices 19a, 19b includes or include a plurality of rolling bodies, the rolling bodies being rotationally supported about a horizontally extending axis in the mounting position and/or about a vertically extending axis in the mounting position and are configured to roll along a guide rail 12a, 12b.

In the shown embodiment, at least one further guide rail 12c is provided, the further guide rail 12c being spaced apart from the two guide rails 12a, 12b in the height direction. Each of the guide rails 12a, 12b, 12c has a longitudinal direction L1.

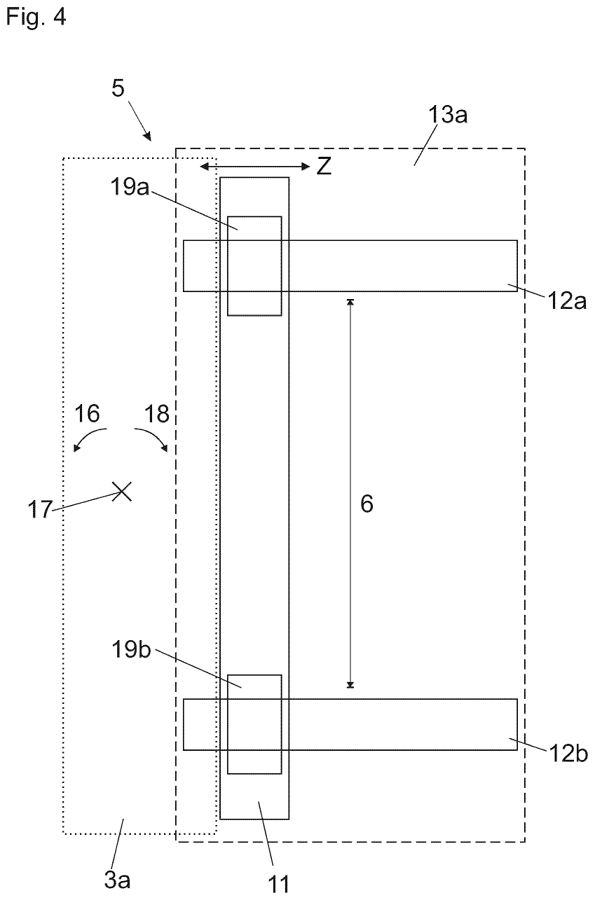

FIG. 4 shows a schematic side view of the guide system 5, in which the first guide rail 12a and the second guide rail 12b are fixed to the furniture wall 13a. The second guide rail 12b is arranged on the furniture wall 13a at a vertical distance 6 from the first guide rail 12a.

The carrier 11 is movably supported in the depth direction Z via the first guide device 19a along the first guide rail 12a, and via the second guide device 19b along the second guide rail 12b. The at least one door wing 3a is pivotally supported on the carrier 11, and the door wing 3a is indicated by a dotted line. The carrier 11 is connected to the two guide devices 19a, 19b in a movement-coupled manner.

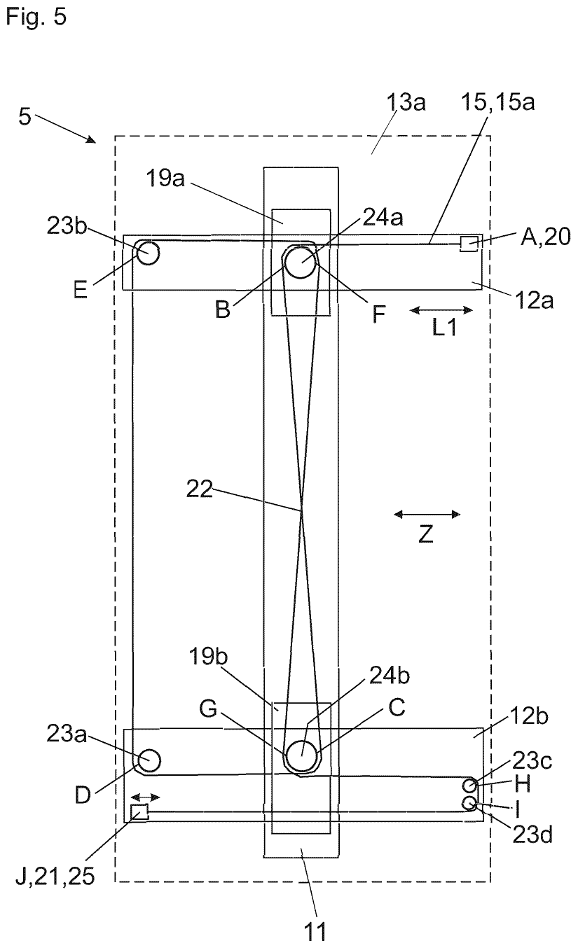

Further, a cable pulley device 15 (FIG. 5) is provided for compensating for a tilting moment of the carrier 11 about a tilting axis 17 by a return moment 18. When the carrier 11 or the door wing 3a is aligned vertically, the tilting axis 17 is aligned horizontally. The cable pulley device 15 thus ensures that the at least one door wing 3a is stably guided in each position, without the guide devices 19a, 19b being tilted relative to the guide rails 12a, 12b.

FIG. 5 shows a schematic side view of the guide system 5. The carrier 11 is movably supported between a retracted end position and an extended end position in the depth direction Z along the two guide rails 12a, 12b. In the shown figure, the carrier 11 is located approximately in a middle position between the retracted end position and the extended end position. The carrier 11 is movably supported along the guide rails 12a, 12b via the two guide devices 19a, 19b.

At least two deflection rollers 24a, 24b for at least one, preferably precisely one, cable 15a of the cable pulley device 15 are rotatably supported on the carrier 11 and/or on the guide devices 19a, 19b.

Reference numerals 23a, 23b, 23c, 23d denote deflection elements, and the cable 15a is stationarily arranged on the deflection elements 23a, 23b, 23c, 23d, that is to say that there is no substantial relative movement between the cable 15a and the deflection elements 23a, 23b, 23c, 23d when the carrier 11 is moved along the guide rails 12a, 12b. The deflection elements 23a, 23b, 23c, 23d are arranged on the guide rails 12a, 12b.

The cable 15a is guided in a crosswise manner via the two deflection rollers 24a, 24b arranged on the two guide devices 19a, 19b and/or on the at least one carrier 11. In this way, a substantial tilting-free movement of the carrier 11 and of the guide devices 19a, 19b can be ensured.

In the shown embodiment, the cable 15a of the cable pulley device 15 is guided as follows:
a first cable end 20 of the cable 15a is arranged, preferably stationarily, on the first guide rail 12a on location A,
the cable 15a is guided around the first deflection roller 24a on location B,
the cable 15a is guided around the second deflection roller 24b on location C,
the cable 15a is guided around the first deflection element 23a on location D,
the cable 15a is guided around the second deflection element 23b on location E,
the cable 15a is guided around the first deflection roller 24a on location F,
the cable 15a is guided around the second deflection roller 24b on location G,
the cable 15a is guided around the third deflection element 23c on location H,
the cable 15a is guided around the fourth deflection element 23d on location I,
a second cable end 21 of the cable 15a is arranged on the second guide rail 12b on location J, preferably in an adjustable manner.

For adjusting a tension of the cable 15a, at least one adjustment device 25 can be provided by which the two cable ends 20, 21 of the cable 15a can be tensioned relative to each other. In the shown embodiment, the adjustment device 25 is arranged on the second guide rail 12b.

In order for the cable 15a to be guided twice around the two deflection rollers 24a, 24b, the two deflection rollers 24a, 24b includes two guide grooves, extending substantially parallel, for guiding the cable 15a. A first cable section of the cable 15a is guided in a first of the two guide grooves, and a second cable section of the cable 15a is guided in second of the two guide grooves.

According to possible embodiments, the cable 15a:
includes a crossing point 22 arranged substantially in the middle of the at least one carrier 11, and/or
includes at least one cable section which is guided, preferably stationarily, between the two guide rails 12a, 12b in a direction extending substantially parallel to the carrier 11 (cable section between location D and location E), and/or
includes at least one cable section which is guided in a direction extending substantially parallel to a longitudinal direction L1 of the first and second guide rails 12a, 12b (cable section between location A and location B, cable section between location C and location D, cable section between location E and location F, cable section between location G and location H, cable section between location I and location J).

Upon a movement of the carrier 11 between the retracted end position and the extended end position, the carrier 11 can be guided along at least one cable section extending substantially parallel to a longitudinal direction L1 of the first and second guide rail 12a, 12b. The cable 15a includes a first cable end 20 which is arranged on a first end of the first guide rail 12a. A second cable end 21 of the cable 15a is arranged on a first end of the second guide rail 12b.

According to possible embodiments:
the first end of the first guide rail 12a and the first end of the second guide rail 12b are arranged diametrically to each other, and/or
a position of at least one of the two cable ends 20, 21 relative to the first end of the first or second guide rail 12a, 12b is adjustable by an adjustment device 25, and/or
at least one of the two cable ends 20, 21 is fixed in position to one of the two guide rails 12a, 12b.

According to a possible embodiment, the cable 15a is guided such that the cable 15a, in a side view onto the furniture wall 13a, forms a first Z-form and at least a second Z-form. Preferably, the two Z-forms are arranged mirror-symmetrically to each other.

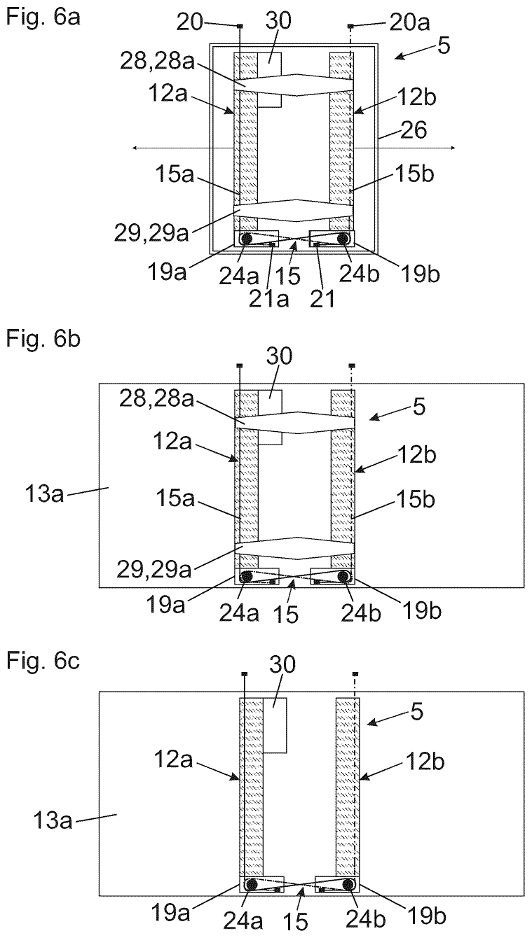

FIG. 6a-6c schematically show the execution of a method for mounting a guide system 5 in temporally subsequent steps. FIG. 6a shows a top view onto the guide system 5 which, in a delivery condition, is arranged in a package 26. The guide system 5 includes an arrangement comprising the guide rails 12a, 12b, and a guide device 19a, 19b for movably guiding the carrier 11 is arranged on each of the guide rails 12a, 12b (FIG. 5). The two guide devices 19a, 19b are movably supported along the two guide rails 12a, 12b.

The two guide rails 12a, 12b are connected to each other via at least one cable 15a, 15b of a cable pulley device 15 for compensating for a tilting moment 16 of the carrier 11 about a tilting axis 17 by a return moment 18 (FIG. 4). In the shown embodiment, two cables 15a, 15b separate from each other are provided. The cables 15a, 15b are guided around the two deflection rollers 24a, 24b of the guide devices 19a, 19b. The second cable 15b is indicated by a dashed line.

The first cable 15a is guided around the two deflection rollers 24a, 24b of the two guide devices 19a, 19b and includes two cable ends 20, 21. The second cable 15b is guided around the two deflection rollers 24a, 24b of the two guide devices 19a, 19b and also includes two cable ends 20a, 21a.

Each of the cable ends 20, 21 of the first cable 15a and/or the cable ends 20a, 21a of the second cable 15b includes a thickening in the form of a stopping element. For example, the thickening can be formed by a crimped ball. However, as described before, only one single cable 15a, 15b can be provided.

A drive device is denoted with reference numeral 30, and the carrier 11 is movable into the retracted end position by the drive device 30 and/or is ejectable from the retracted end position by the drive device 30. The drive device 30 can include at least one damping device, for example at least one hydraulic piston-cylinder-unit, for dampening a movement of the carrier 11.

FIG. 6b shows that at least one furniture wall 13a is provided, the furniture wall 13a being aligned horizontally in the shown figure. Of course, the mounting operation of the guide system 5 can also be performed on a vertically aligned furniture wall 13a. The arrangement can be removed from the package 26 by at least one assembly aid 28, 29, preferably by a handle 28a, 29b, and/or can be positioned, preferably rested, on the at least one furniture wall 13a.

FIG. 6c shows that the at least one assembly aid 28, 29 is removed after the arrangement has been positioned on the at least one furniture wall 13a.

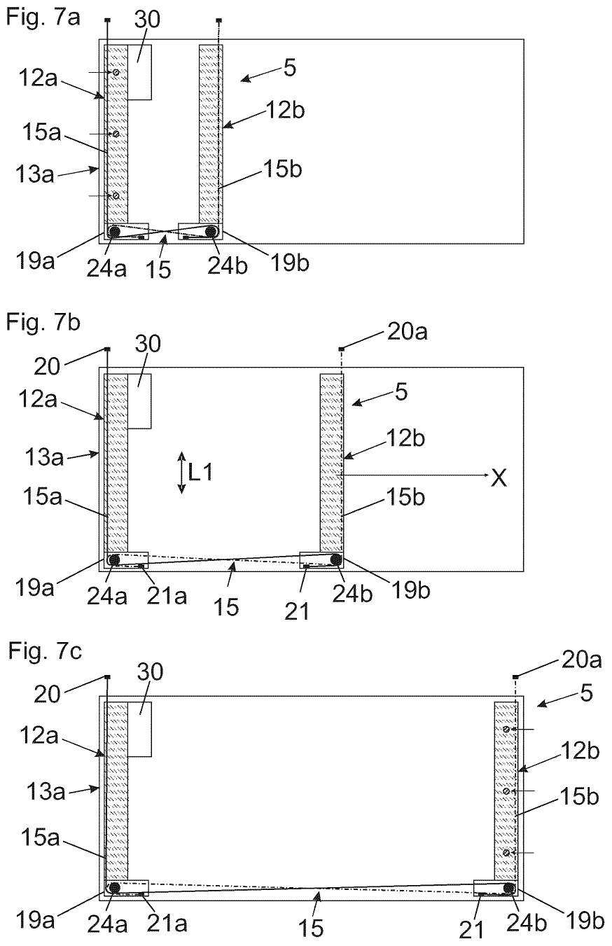

FIG. 7a-7c show the continuation of the method according to FIGS. 6a-6c.

FIG. 7a shows that one of the two guide rails 12a, 12b is fixed, preferably screwed, to the at least one furniture wall 13a, preferably on an end of the at least one furniture wall 13a. In the present case, the first guide rail 12a has been fixed to a first end of the furniture wall 13a, and the first end of the furniture wall 13a corresponds to an upper end of the furniture wall 13a in a mounted condition.

FIG. 7b shows that the second guide rail 12b is pulled relative to the first guide rail 12a, which is already fixed to the at least one furniture wall 13a, in a direction extending transversely to the longitudinal direction L1 of the guide rails 12a, 12b, thereby increasing a distance between the two guide rails 12a, 12b. By increasing the distance between the guide rails 12a, 12b in the direction X, a length of a cable section of the cable 15a, 15b, arranged between the two guide rails 12a,12b, between the two guide rails 12a, 12b is increased. During the increase of the length of the cable section, a cable end 20, 20a of the at least one cable 15a, 15b is shortened. Preferably, the cable end 20, 20a projects over at least one guide rail 12a, 12b.

FIG. 7c shows that the second guide rail 12b, in a further method step, is fixed, preferably screwed, to the at least one furniture wall 13a, preferably to an end of the at least one furniture wall 13a. In the present case, the second guide rail 12b has been fixed to a second end of the furniture wall 13a. The second end of the furniture wall 13a corresponds to a lower end of the furniture wall 13a in a mounted condition.

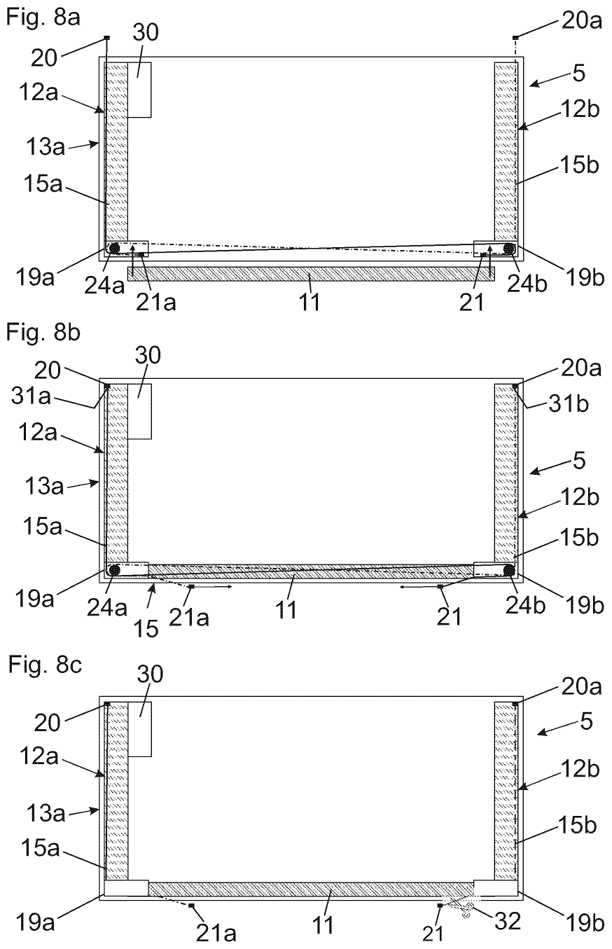

FIG. 8a-8c show schematically the continuation of the method according to FIGS. 7a-7c in temporally subsequent steps.

FIG. 8a shows that in a further method step, the at least one carrier 11 is provided and can be connected, preferably pre-fixed, to the guide devices 19a, 19b.

FIG. 8b shows that in a further method step, the at least one cable 15a, 15b, is tensioned by applying a pulling force, preferably manually, to the at least one cable 15a, 15b, and at least one cable end 21, 21a is fixed in a tensioned condition of the cable 15a, 15b. Preferably, an opposing cable end 20, 20a of the cable 15a, 15b abuts against an abutment 31a, 31b. The two abutments 31a, 31b for the cable 15a, 15b are preferably formed or arranged on the two guide rails 12a, 12b.

The fixing of tensioned cable 15a, 15b can be performed, for example, by an automatic cable tensioning device, in which a clamping device pressurized by a spring presses against the cable 15a, 15b in a direction extending transversely to a longitudinal extension of the cable 15a, 15b. The clamping device is movably supported between a clamping position in which the cable 15a, 15b is clamped, and a release position in which the cable 15a, 15b is unblocked. By a handle, the clamping device is movable from the clamping position into the release position against the action of the spring.

FIG. 8c shows that, after the cable 15a, 15b has been tensioned and the cable end 21, 21a has been fixed, a protruding cable end is shortened and/or stowed. The protruding cable end 21, 21a can be shortened by a tool 32, or example in the form of a scissors. The two cables 15a, 15b are now tensioned and have been brought to the correct length.

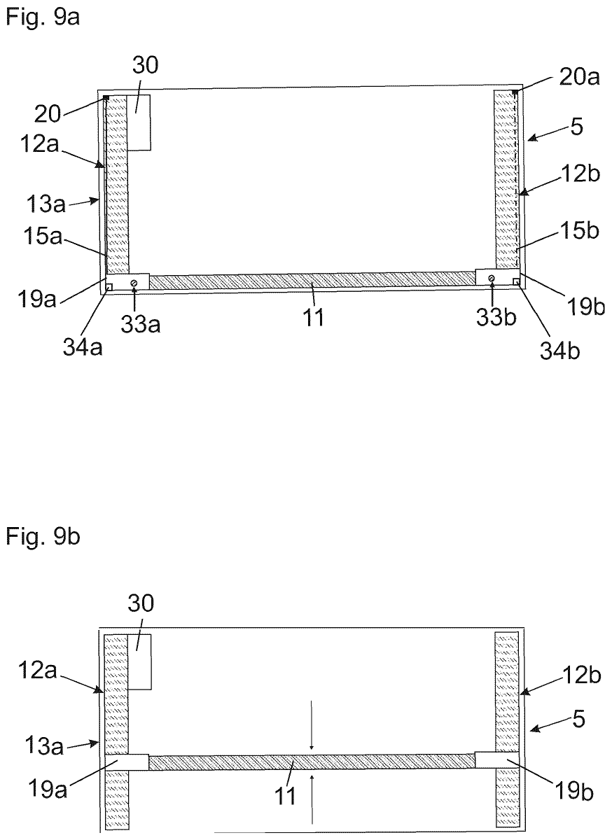

FIGS. 9a, 9b show the continuation of the method according to FIGS. 8a-8c in temporally subsequent steps. FIG. 9a shows that the carrier 11 pre-fixed to the guide devices 19a, 19b is now finally fixed to the guide device 19a, 19b. For this purpose, each of the guide devices 19a, 19b includes at least one fastening location 33a, 33b. The at least one fastening location 33a, 33b is configured so as to screw and/or so as to releasably lock the carrier 11 with the guide devices 19a, 19b.

FIG. 9b shows that all components of the guide system 5 have now been duly positioned, and the guide devices 19a, 19b of the carrier 11 are movable by the cable pulley device 15 substantially in a tilting-free manner along the two guide rails 12a, 12b. In a delivery condition, the guide devices 19a, 19b can be held in position on the guide rails 12a, 12b by at least one transport securing device 34a, 34b. The at least one transport securing device 34a, 34b is released after the guide rails 12a, 12b have been mounted to the furniture wall 13a and/or after the carrier 11 has been connected to the guide devices 19a, 19b.

The guide system 5 according to the invention includes an arrangement comprising the at least two guide rails 12a, 12b and the at least one cable 15a, 15b arranged therebetween. In a delivery condition of the arrangement, the two guide rails 12a, 12b are arranged at a first distance in a direction extending transversely to the longitudinal direction L1 of the two guide rails 12a, 12b, and are arranged at a second distance which is increased with respect to the first distance in a mounted condition. Upon a transfer of the two guide rails 12a, 12b from the delivery condition into the mounted condition, a length of at least one cable section of the cable 15a, 16b arranged between the two guide rails 12a, 12b can be increased.

According to an embodiment, in the delivery condition, a cable end 20, 20a of the at least one cable 15a, 15b projects over a component of the arrangement, preferably over one of the guide rails 12a, 12b, and can be shortened upon a transfer of the two guide rails 12a, 12b from the delivery condition into the mounted condition.

1. A method of mounting a guide system for guiding at least one movably-supported door wing along a furniture wall, the guide system including at least two guide rails having a longitudinal direction and each having at least one guide device supported thereon for guiding a carrier to be connected to the at least one door wing, wherein the two guide rails are connected to each other via at least one cable of a cable pulley device for compensating for a tilting moment of the carrier about a tilting axis by a return moment, the method comprising, preferably in the specified order:
providing at least one furniture wall,
positioning, preferably resting, an arrangement comprising the at least two guide rails and the at least one cable arranged therebetween on the at least one furniture wall,
fixing, preferably screwing, one of the two guide rails to the at least one furniture wall, preferably to an end of the at least one furniture wall,
moving the other of the two guide rails relative to the guide rail that is already fixed to the at least one furniture wall in a direction extending transversely to the longitudinal direction of the guide rails, thereby increasing a distance between the two guide rails,
increasing a length of at least one cable section of the cable arranged between the two guide rails when the distance between the two guide rails is increased.

2. The method according to claim 1, further comprising fixing the other of the two guide rails, preferably by screwing, to the at least one furniture wall, preferably to an end of the at least one furniture wall.

3. The method according to claim 1, wherein the arrangement is removed from at least one package by means of at least one assembly aid, preferably by a handle, and/or is positioned, preferably rested, on the at least one furniture wall, preferably wherein the at least one assembly aid is removed after the arrangement has been positioned on the at least one furniture wall.

4. The method according to claim 1, wherein during the increase of the length of the at least one cable section, a cable end of the at least one cable is shortened, preferably wherein the cable end projects over at least one guide rail.

5. The method according to claim 1, wherein in a further method step, the at least one carrier is provided and is connected, preferably pre-fixed, to the guide devices.

6. The method according to claim 1, wherein in a further method step, the at least one cable is tensioned by applying a pulling force, preferably manually, to the at least one cable and at least one cable end is fixed in a tensioned condition of the cable, preferably wherein an opposing cable end of the cable abuts against at least one abutment, preferably wherein the at least one abutment is formed or arranged on a guide rail.

7. The method according to claim 6, wherein after tensioning the cable and fixing the cable end, a projecting cable end is shortened and/or stowed, preferably wherein subsequently a carrier pre-fixed to the guide devices is finally fixed to the guide devices.

8. The method according to claim 1, wherein the guide devices, in a delivery condition, are held in position on the guide rails by at least one transport securing device, wherein the at least one transport securing device is released after the guide rails have been mounted and/or after the carrier has been connected to the guide devices.

9. A guide system for guiding at least one movably-supported door wing along a furniture wall, the guide system comprising:
at least two guide rails having a longitudinal direction and each having at least one guide device supported thereon for guiding a carrier to be connected to the at least one door wing,
wherein the at least two guide rails are connected to each other via at least one cable of a cable pulley device for compensating for a tilting moment of the carrier about a tilting axis by a return moment, wherein the guide system includes an arrangement comprising the at least two guide rails and the at least one cable arranged therebetween, wherein the two guide rails, in a delivery condition of the arrangement, are arranged at a first distance in a direction extending transversely to the longitudinal direction of the two guide rails, and are arranged, in a mounted condition on the furniture wall, at a second distance which is larger than the first distance, wherein upon a transfer of the two guide rails from the delivery condition into the mounted position, a length of at least one cable section of the cable arranged between the two guide rails can be increased, preferably wherein in the delivery condition of the arrangement, a cable end of the at least one cable projects over a component of the arrangement, preferably over one of the two guide rails, and can be shortened upon a transfer of the two guide rails from the delivery condition into the mounted condition.

10. The guide system according to claim 9, wherein the two guide rails, in the delivery condition of the arrangement, are connected to each other via at least one assembly aid, preferably via a handle, by which the arrangement can be positioned, preferably rested, on the at least one furniture wall.

11. The guide system according to claim 9, wherein the arrangement, in the delivery condition, is arranged in a package.

12. The guide system according to claim 9, wherein the guide devices, in a delivery condition, are held in position on the guide rails by at least one transport securing device, wherein the at least one transport securing device is releasable after the guide rails have been mounted to the furniture wall and/or after the carrier has been connected to the guide devices.
